(19) United States
(12) Patent Application Publication
(10) Pub. No.: US 2026/0264452 A1
(43) Pub. Date: Sep. 10, 2026

(54) TIRE WITH ASYMMETRICAL PROFILE AND SYMMETRICAL CARCASS PASSAGE

(71) Applicant: COMPAGNIE GENERALE DES ETABLISSEMENTS MICHELIN, Clermont-Ferrand (FR)

(72) Inventor: BRUNO GUIMARD, Clermont-Ferrand (FR)

(21) Appl. No.: 19/166,350

(22) PCT Filed: Mar. 7, 2024
(86) PCT No.: PCT/EP2024/055953

§ 371 Date: Sep. 17, 2025

(30) Foreign Application Priority Data
Mar. 17, 2023 (FR) 2302475

(51) Int. Cl. B60C 3/06

(52) U.S. Cl. CPC B60C 3/06

(57) ABSTRACT

A tire (10) comprises first and second beads (321, 322) comprising circumferential reinforcing elements (331, 332) for anchoring the carcass layer (36) arranged substantially symmetrically relative to the median plane (M) of the rim. The tire has axial distances C11, C21, at the equator (E), between the median plane (M) of the rim and the carcass layer (36) which passes into the first and second sidewalls (301, 302). The tire has axial distances F1, F2, at the equator (E), between the median plane (M) of the rim and the theoretical external surface of the first and second sidewalls (301, 302). 2×F1>LN with LN being the nominal axial width of the tire according to the ETRTO Standards Manual 2021. |C11−C21|≤3.0 mm and F1−C11>F2−C21. G1≤6.0 mm and/or G2≤6.0 mm.

The present invention relates to a tyre for a passenger vehicle. A tyre means a casing intended to form a cavity by cooperating with a support element, for example a rim, this cavity being able to be pressurized or not to a pressure higher than atmospheric pressure. A tyre according to the invention has a structure of substantially toroidal shape exhibiting symmetry of revolution about a main axis of the tyre.

There are known from the prior art tyres for a conventional passenger vehicle having an outer side and an inner side which are imposed when the tyre is mounted on the vehicle. These tyres normally comprise a crown, first and second beads, first and second sidewalls which connect each first and second bead to the crown, respectively. These tyres do not have any rim protector. A rim protector is a projecting circumferential rib which is located in the radially lower portion of the sidewall of the tyre and which is intended to protect the rim edge from any damage.

These tyres are mounted on their support element, for example, a rim for forming mounted assemblies. These mounted assemblies are manipulated a number of times before being mounted on the passenger vehicle for which they are intended.

A first problem is that, during these manipulations, the mounted assemblies, particularly the rims, are exposed to shocks which often involve indentations or scratches which make it impossible to sell the vehicle in this state and which require the mounted assembly to be repaired and changed.

A second problem relates to the appearance of the vehicle. This is because it is desirable for the external surface of the mounted assembly, in particular the external surface of the tyre, to be included within the continuity of the body. In particular, a mounted assembly being arranged in a manner significantly set back from the external line of the body which delimits the wheel arch is often considered to be unattractive.

Another problem is the autonomy of vehicles, and more advantageously electric vehicles which automotive manufacturers seek to increase without using additional batteries.

The invention relates to a high-performance tyre which allows the mounting rim of the tyre to be better protected and the general appearance of the vehicle to be improved without for all that impairing, or even improving, the autonomy of the vehicles.

To this end, the invention relates to a tyre for a passenger vehicle, the tyre having an outer side and an inner side which are imposed when the tyre is mounted on the vehicle, the tyre comprising a crown comprising a crown reinforcement, first and second beads, first and second sidewalls which connect each first and second bead to the crown, respectively, a carcass reinforcement comprising at least one carcass layer, the or each carcass layer i being anchored in each first and second bead and extending radially in each first and second sidewall and axially in the crown radially internally with respect to the crown reinforcement,
the tyre comprising a median plane of the rim which is constituted by the median plane of the measurement rim of the tyre according to the ETRTO Standards Manual 2021 when the tyre is mounted on the measurement rim, the first sidewall and the first bead being arranged at the same side of the median plane of the rim as the outer side of the tyre, the second sidewall and the second bead being arranged at the same side of the median plane of the rim as the inner side of the tyre,
each first and second bead comprising at least first and second circumferential reinforcing elements for anchoring the carcass layer or at least one of the carcass layers i, respectively, the first and second circumferential reinforcing elements being arranged substantially symmetrically relative to the median plane of the rim,
the tyre having an axial distance C1i, at the equator, between the median plane of the rim and a first axially outermost point of each carcass layer i which passes into the first sidewall,
the tyre having an axial distance C2i, at the equator, between the median plane of the rim and a second axially outermost point of the carcass layer i which passes into the second sidewall,
the tyre having an axial distance F1, at the equator, between the median plane of the rim and a first point of a theoretical external surface of the first sidewall,
the tyre having an axial distance F2, at the equator, between the median plane of the rim and a second point of the theoretical external surface of the second sidewall,
the tyre having an axial thickness G1, at the equator, between a point of a theoretical internal surface of an internal cavity of the tyre and a first axially innermost point of the carcass layer which is axially innermost with respect to the equator passing into the first sidewall,
the tyre having an axial thickness G2, at the equator, between a point of a theoretical internal surface of the internal cavity of the tyre and a second axially innermost point of the carcass layer which is axially innermost with respect to the equator passing into the second sidewall, in which tyre 2×F1>LN with LN being the nominal axial width of the tyre according to the ETRTO Standards Manual 2021, |C1i−C2i|≤3.0 mm and F1−C1i>F2−C2i and G1≤6.0 mm and/or G2≤6.0 mm.

The invention can be more simply summarized as defining an asymmetrical tyre with a symmetrical carcass reinforcement. This is because the fact that the first and second annular reinforcement elements are arranged substantially symmetrically relative to the median plane of the rim and the fact that |C1i−C2i|≤3 mm make the or each carcass layer i which is anchored in each first and second bead substantially symmetrical relative to the median plane of the rim.

This symmetry of the or each carcass layer i allows the performance levels usually expected of a tyre to be ensured unlike with a tyre in which there would be at least one carcass layer arranged non-symmetrically relative to the median plane of the rim and which would result in conicity effects leading to imbalancing of the tyre.

The fact that F1−C1i>F2−C2i allows an asymmetry of the thicknesses of the sidewalls to be characterized. This asymmetry which is associated with the fact that 2×F1>LN with LN being the nominal axial width LN of the tyre according to the manual of the standard of the European Tyre and Rim Technical Organisation or ETRTO 2021 allows, on the one hand, the mounting rim to be effectively protected. This is because the protection conferred by the tyre is improved by thickening the first sidewall which is arranged at the outer side and by causing the real axial width of the tyre to exceed the nominal axial width LN.

This asymmetry which is associated with the fact that 2×F1>LN allows, on the other hand, the external surface of the tyre to be made flush with the external body line which delimits the wheel arch. The asymmetry and the value of F1 will be adapted by the person skilled in the art as a function of the external body line of the vehicle on which the tyre is intended to be mounted.

The thickening of the first sidewall which is arranged at the outer side is compensated for by a thinning of the second sidewall which is arranged at the inner side. On the one hand, this thinning does not impair the protection of the mounted assemblies because any potential shocks which occur at the inner side bring about indentations or scratches which are not visible and are therefore acceptable from the point of view of selling the vehicle. On the other hand, this thinning does not impair the appearance of the vehicle taking into account the invisibility of the second sidewall which is arranged at the inner side and which is hidden when the mounted assembly is mounted on the vehicle. Finally, the thinning allows at least partial compensation for the mass added to thicken the first sidewall at the outer side, which allows the quantity of material used to be contained.

The tyre according to the invention also has an improved aerodynamic performance level relative to the tyre of the prior art, which is even more surprising since a reduction in the aerodynamic performance level might have been expected as a result of the thickening of the first sidewall arranged at the outer side. Conversely, the invention teaches that the presence of a second relatively thin sidewall which is arranged at the inner side allows an aerodynamic benefit to be derived which is greater than the aerodynamic deterioration associated with the presence of a first relatively thick sidewall which is arranged at the outer side. Thus, the autonomy of the vehicle fitted with the tyre according to the invention is improved.

One and/or other of the relatively small axial thicknesses G1, G2 allows a tyre to be characterized which does not allow a flat running function to be ensured. A tyre having one and/or other of the relatively small axial thicknesses G1, G2 has reduced hysteresis and therefore a relatively small resistance to rolling and, all things otherwise being equal, in all cases smaller than a tyre adapted for similar flat running having axial thicknesses G1, G2 which are far greater. Preferably, G1≤6.0 mm and G2≤6.0 mm.

The tyre according to the invention is not a tyre suitable for running flat. A tyre suitable for running flat is suitable for running while the pressure of the internal cavity of the tyre is equal to atmospheric pressure (through improper use of language, it is often said that the pressure is zero, whereas it is the overpressure with respect to atmospheric pressure that is zero). A tyre suitable for running flat comprises self-supporting sidewalls, i.e., sidewalls that are capable, when at a pressure equal to atmospheric pressure, of bearing the same load, for example the rated load as indicated in the European Tyre and Rim Technical Organisation (ETRTO) Standards Manual 2021, as the tyre is capable of bearing when inflated to its usual inflation pressure, for example its nominal inflation pressure as indicated in the ETRTO Standards Manual 2021, over a distance greater than or equal to a certain threshold at a speed greater than or equal to 80 km/h. A tyre suitable for running flat preferably has a specific marking indicating the ability of the tyre to run flat. Thus, for example, markings in the form of the following acronyms are used, without this list being exhaustive: “ZP” for “Zero Pressure”, “SST” for “Self Supporting Technology”, “SSR” for “Self Supporting Runflat Tyre”, “RF” for “Run Flat”, “RFT” for “Run Flat Tyre”, “EXT” for “EXTended”, “ZP-SR” for “Zero Pressure Short Range” or indeed “ZPS” for “Zero Pressure System”. Another specific marking indicating the ability of the tyre to run flat is the presence of the letter “F” in the tyre size number. Thus, tyres of the size 225/40R18 or 225/40ZR18 are marked 225/40RF18 or 225/40ZRF18 if they are suitable for running flat.

The tyre has an internal surface which delimits the inflation cavity of the tyre once the tyre is mounted on a mounting support, for example a rim.

The term “arranged substantially symmetrically relative to the median plane of the rim” is intended to be understood to mean that the position of the first circumferential reinforcing element is substantially symmetrical for the position of the second circumferential reinforcing element relative to the median plane of the rim so as to ensure the symmetry of each carcass layer which is anchored by means of these at least first and second circumferential reinforcing elements. Thus, for example, in the case of the first and second circumferential reinforcing elements with an identical generally annular form, the geometric centres are equidistant from the median plane of the rim.

The theoretical external surface is the surface of the tyre that has no recessed or protruding moulded elements and that follows the curvature of the exterior surface of the tyre without any abrupt local variation. This theoretical external surface acts as a reference for determining the depth of the height of the recessed or protruding moulded elements. Thus, the theoretical external surface is the entity formed by the smooth surface that passes through that surface of the tyre that does not have recessed or protruding moulded elements and by an imaginary surface that follows the curvature of the exterior face of the tyre and forms a continuous continuation of the smooth surface discounting the recessed or protruding moulded elements.

Similarly, the theoretical internal surface of the cavity is the internal surface of the tyre that has no recessed or protruding moulded elements and that follows the curvature of the internal surface of the tyre without any abrupt local variation. This theoretical internal surface acts as a reference for determining the depth of the height of the recessed or protruding moulded elements. Thus, the theoretical internal surface is the entity formed by the smooth surface that passes through that surface of the tyre that does not have recessed or protruding moulded elements and by an imaginary surface that follows the curvature of the internal surface of the tyre and forms a continuous continuation of the smooth surface discounting the recessed or protruding moulded elements.

The axial distances F1 and F2 are measured on a tyre which is mounted on a measurement rim according to the ETRTO Standards Manual 2021 and which is inflated to 2.5 bar after being positioned in the median plane of the rim relative to the tyre. The distances C1i, C2i, G1 and G2 are measured under a pressure of 2.5 bar, for example, by pressurizing to 2.5 bar a section of the tyre which is mounted on a measurement rim according to the ETRTO Standards Manual 2021, for example, by means of an inflatable pocket which is inserted between the measurement rim and the section of the tyre. It is also possible to carry out a profile measurement of the rim alone and subsequently to carry out a profile measurement with the tyre mounted on the rim. The superimposition of the two measured profiles allows determination of the axial distances F1 and F2, then F1-C1i and F2-C2i and finally C1i and C2i. It is further possible to cite the existence of rims which are fitted with LASER measurement devices which are capable of directly measuring C1i and C2i.

Each first and second axially outermost point of each carcass layer i belongs to an axially exterior surface of each carcass layer i. For each carcass layer, a continuous surface, referred to as the axially exterior surface of said carcass layer i, passing through the axially outermost point of each carcass reinforcing element and a continuous surface, referred to as the axially interior surface of said carcass layer i, passing through the axially innermost point of each carcass reinforcing element, are defined.

The or each carcass layer comprises carcass reinforcing elements which extend from a first axial edge to a second axial edge of the or each carcass layer. The expression “reinforcing element” means an element providing mechanical reinforcement to the polymer matrix in which this reinforcing element is intended to be embedded.

Preferably, the reinforcing element is filamentary, which means to say that the element has a length at least 10 times greater than the largest dimension of its cross section, regardless of the shape of the latter: circular, elliptical, oblong, polygonal, in particular rectangular or square or oval. In the case of a rectangular cross section, the filamentary reinforcing element has the shape of a strip.

The matrix is said to be polymeric because it is based on a polymeric composition, this polymeric composition possibly comprising one or more polymers, for example selected from thermoplastic polymers, thermosetting polymers, elastomers, thermoplastic elastomers, but also fillers and other components usually used in the field of compositions for tyres, in particular compositions for embedding reinforcing elements.

For a given dimension, the nominal axial width LN is the width mentioned in the ETRTO Standards Manual 2021 under the heading “Design-Section Width”. Thus, for example, for a tyre with a dimension 235/55R18, the nominal axial width LN is 245.0 mm.

The expression “inner and outer sides that are imposed when the tyre is mounted on the vehicle” means that the tyre is designed so that one of its sides is arranged on the inner side and the other of its sides is arranged on the outer side. This orientation imposed by the tyre manufacturer makes it possible to ensure that the tyre operates as expected. Specifically, the mounting of a tyre with an orientation different from the one imposed by the manufacturer could result in unexpected behaviour of the vehicle. The expression “outer side” is understood to mean the side of the tyre that is entirely visible from the outside of the vehicle when the tyre is fitted on the vehicle. “Inner side” is understood to mean the side of the tyre that faces the wheel arch of the vehicle on which it is fitted. Generally, the tyre has a marking indicating the inner side and the outer side.

The tyre according to the invention has a substantially toroidal shape about an axis of revolution substantially coinciding with the axis of rotation of the tyre. This axis of revolution defines three directions conventionally used by those skilled in the art: an axial direction, a circumferential direction and a radial direction.

The expression “axial direction” means the direction substantially parallel to the axis of revolution of the tyre, which is to say the axis of rotation of the tyre.

Circumferential direction is given to mean the direction substantially perpendicular both to the axial direction and to a radius of the tyre (in other words, tangent to a circle centred on the axis of rotation of the tyre).

Radial direction is given to mean the direction along a radius of the tyre, that is, any direction that intersects the axis of rotation of the tyre and is substantially perpendicular to that axis.

The term “median plane of the rim” (designated M) is given to mean the plane perpendicular to the rotation axis of the tyre which is located with axial equidistance from the two edges or flanges of the measurement rim according to the ETRTO Standards Manual 2021. For the majority of the tyres for passenger vehicles, the measurement rim has a type of J or B profile, the edges or flanges of which are axially remote from each other by a distance A (as mentioned in the ETRTO Standards Manual 2021). The median plane of the rim is thus located at an axial distance A/2 from each of the edges or flanges of the measurement rim. The measurement rim is dependent on the dimension of the tyre and is indicated in the ETRTO Standards Manual 2021. Thus, for a dimension 235/55R 18, the measurement rim has a code 7.5 and a profile type J.

The equatorial circumferential plane of the tyre is understood to be, in a meridian sectional plane, the plane passing through the equator (designated E) of the tyre, perpendicular to the median plane and to the radial direction. The equator of the tyre is, in a meridian plane of section (plane perpendicular to the circumferential direction and parallel to the radial and axial directions), the axis which is parallel to the rotation axis of the tyre and which passes through first and second points of the internal surface which delimits the internal cavity of the tyre, the first and second points of the internal surface being the points of the internal surface which are axially furthest away from each other and which belong to each first and second sidewall, respectively.

The expression “meridian plane” is given to mean a plane parallel to the rotation axis of the tyre and containing the axis of rotation of the tyre and perpendicular to the circumferential direction.

The expressions “radially inner/radially on the inside” and “radially outer/radially on the outside” mean closer to the axis of rotation of the tyre and further away from the axis of rotation of the tyre, respectively. The expressions “axially inner/inside” and “axially outer/outside” mean closer to the median plane of the tyre and further away from the median plane of the tyre, respectively.

Bead is given to mean the portion of the tyre intended to allow the tyre to be attached to a mounting support, for example a wheel comprising a rim. Thus, each bead is notably intended to be in contact with a flange of the rim allowing it to be attached.

Any range of values denoted by the expression “between a and b” represents the range of values extending from more than a to less than b (that is, excluding the end-points a and b), whereas any range of values denoted by the expression “from a to b” means the range of values extending from a to b (that is, including the strict end-points a and b).

In preferred embodiments of the invention, the tyres are intended for passenger vehicles as defined within the meaning of the ETRTO Standards Manual 2021. Such a tyre has a section in a meridian section plane that is characterized by a section height H and a nominal section width S within the meaning of the ETRTO Standards Manual 2021, such that the ratio H/S, expressed as a percentage, is at most equal to 90 and is at least equal to 25, and the nominal section width S is at least equal to 115 mm and at most equal to 385 mm. Moreover, the diameter at the flange D, defining the diameter of the mounting rim of the tyre, is at least equal to 12 inches, preferably at least equal to 16 inches and at most equal to 24 inches.

Conventionally, the crown comprises a tread and a crown reinforcement which extends into the crown in the circumferential direction, the crown reinforcement being arranged radially between the tread and the carcass reinforcement.

In the conventional way, the crown reinforcement comprises at least one crown layer comprising reinforcing elements. These reinforcing elements are preferably textile or metallic filamentary elements.

In embodiments for obtaining performance levels of tyres known as radial tyres, for example as defined by the ETRTO, each filamentary carcass reinforcement element extending substantially in a main direction that forms an angle, in terms of absolute value, ranging from 80° to 90° with the circumferential direction of the tyre.

In preferred embodiments in which the or each carcass layer is made as symmetrical as possible relative to the median plane of the rim, |C1i−C2i|≤2.0 mm, preferably |C1i−C2i|≤1.0 mm and more preferably |C1i−C2i|≤0.5 mm.

In a very preferred manner, for each radial dimension r given, each point of the or each carcass layer i located at the outer side has an axial distance relative to the median plane C1ir, each point of the carcass layer i located at the outer inner at the same radial dimension r has an axial distance relative to the median plane C2ir, this gives |C1ir−C2ir|≤3.0 mm, preferably |C1ir−C2ir|≤2.0 mm, more preferably |C1ir−C2ir|≤1.0 mm and very preferably |C1ir−C2ir|≤0.5 mm. The radial dimension can be determined relative to any fixed point of the tyre, for example, relative to the radially innermost point of the tyre.

In embodiments in which the asymmetry of the thicknesses of the sidewalls is relatively great, (F1−C1i)−(F2−C2i)≥2.0 mm, preferably (F1−C1i)−(F2−C2i)>2.5 mm.

In embodiments in which the asymmetry of the thicknesses of the sidewalls remains contained, (F1−C1i)−(F2−C2i)≤5.0 mm, preferably (F1−C1i)−(F2−C2i)<3.0 mm. This is because an excessively great asymmetry of the thicknesses of the sidewalls would generate flexion stiffnesses of the sidewalls which are excessively different so that the carcass reinforcement would not be arranged symmetrically relative to the median plane of the rim when the tyre is inflated.

In advantageous but optional embodiments, in which the axial thickness G1 and/or G2 is even further reduced, G1≤4.0 mm and/or G2≤4.0 mm, preferably G1≤3.0 mm and/or G2≤3.0 mm. Advantageously, G1≤4.0 mm and G2≤4.0 mm, preferably G1≤3.0 mm and G2≤3.0 mm.

In advantageous but optional embodiments, in which the cavity is made as symmetrical as possible relative to the median plane of the rim, |G1−G2|≤3.0 mm, preferably |G1−G2|≤2.0 mm, more preferably |G1−G2|≤1.0 mm and even more preferably |G1−G2|≤0.5 mm.

In advantageous but optional embodiments, the tyre has an axial thickness E1, at the equator, between the first point of the theoretical exterior surface of the first sidewall and the first axially outermost point of the carcass layer which is axially outermost at the equator such that E1≥3.0 mm. In other words, F1−C1e≥3.0 mm where C1e designates the value of the distance C1i from the carcass layer which is axially outermost at the equator.

In advantageous but optional embodiments, the tyre has an axial thickness E1, at the equator, between the first point of the theoretical exterior surface of the first sidewall and the first axially outermost point of the carcass layer which is axially outermost at the equator such that E1≤6.0 mm. In other words, F1−C1e≤6.0 mm where C1e designates the value of the distance C1i from the carcass layer which is axially outermost at the equator.

In advantageous but optional embodiments, the tyre has an axial thickness E2, at the equator, between the second point of the theoretical exterior surface of the second sidewall and the second axially outermost point of the carcass layer which is axially outermost at the equator such that E2≥1.0 mm. In other words, F2−C2e≥1.0 mm where C2e designates the value of the distance C2i from the carcass layer which is axially outermost at the equator.

In advantageous but optional embodiments, the tyre has an axial thickness E2, at the equator, between the second point of the theoretical exterior surface of the second sidewall and the second axially outermost point of the carcass layer which is axially outermost at the equator such that E2≤3.0 mm. In other words, F2−C2e≤3.0 mm where C2e designates the value of the distance C2i from the carcass layer which is axially outermost at the equator. The smaller is the axial thickness E2, the greater is the increase in aerodynamic performance level.

In the preceding embodiments, in the variants in which the axially outermost carcass layer at the equator has a superimposition on itself at the equator, the axially outermost point is therefore the point located on the superimposed portion which is axially outermost at the equator. In other variants in which the axially outermost carcass layer at the equator does not have a superimposition on itself at the equator, the axially outermost point is therefore the axially outermost point of only the portion present at the equator.

In embodiments which require a width of the tyre that is relatively great, 2×F1≥LN+0.5 mm, preferably 2×F1≥LN+1.0 mm, F1 and LN being expressed in mm.

In order to comply with the regulatory constraints of the ETRTO, the axial width of the tyre at the equator is preferably less than or equal to the maximum axial width of the tyre according to the ETRTO Standards Manual 2021.

The axial width of the tyre at the equator is measured by pressurizing to 2.5 bar the tyre which is mounted on a measurement rim according to the ETRTO Standards Manual 2021.

In advantageous but optional embodiments, the tyre comprises a tread surface having an axial width LS such that LR−LS≥10.0 mm with LR being the reference width of the tread surface of the tyre according to the ETRTO Standards Manual 2021, LS being determined at 80% of the load capacity of the tyre of the ETRTO Standards Manual 2021 and at a pressure of 2.5 bar.

Having an axial width LS of the tread surface which is significantly less than the reference width LR, the contact surface with the underlying ground is reduced, which allows a reduction in the noise generated by the tyre. Furthermore, the grip of the tyre on wet ground is improved. In these embodiments, the tyre therefore has a particularly optimized profile, wherein, instead of widening the tread in order to geometrically accompany the presence of the first sidewall at the relatively thick outer side, the axial width of the tread surface is limited for reasons of noise and grip on wet ground.

Conventionally, the tread surface is axially delimited by first and second axial edges. The axial width LS is the width measured in the axial direction between the first and second axial edges. The first and second axial edges of the tread surface are determined on a tyre which is mounted on a nominal rim in the sense of the ETRTO Standards Manual 2021 and inflated to a pressure of 2.5 bar. The first and second axial edges of the tread surface are arranged on either side of the median plane of the tyre and formed by lines substantially parallel to the circumferential direction of the tyre. If there is an obvious boundary between the tread surface and the rest of the tyre, the first and second axial edges of the tread surface are simply determined. If the tread surface is continuous with respect to the external surfaces of the sidewalls of the tyre, it is possible, for example, to determine the first and second axial edges by loading the tyre to 80% of its load capacity according to the ETRTO Standards Manual 2021 and to identify the first and second axial edges as the axial limits of the tread band in contact with the ground.

The reference width LR of the tread band is the reference width of the ETRTO Standards Manual 2021 described on page PC.7 of the part “DESIGN GUIDE Passenger Car Tyres” of the manual and defined by LR=(1.075−0.005×ar)×s\hat{ }(1.001) with s being the theoretical flange size at the measurement rim and ar being the nominal aspect ratio.

In advantageous embodiments which allow an even greater improvement of the autonomy of the vehicles while improving the aerodynamic performance level of the tyre, the tyre comprising a first portion, called the shoulder portion, of the first sidewall extending from a first axial edge of the tread surface as far as the equator, the first shoulder portion has a theoretical exterior surface having a minimum radius of curvature greater than or equal to 25.0 mm. The greater is the minimum radius of curvature, the better is the aerodynamic performance of the tyre.

The radius of curvature at the first shoulder portion may be variable. Thus, the minimum radius of curvature is the smallest value of the values of the radius of curvature at the first shoulder portion.

Advantageously, the tyre comprising a first portion, called the shoulder portion, of the first sidewall which extends from a first axial edge of the tread surface as far as the equator, the first shoulder portion has a theoretical exterior surface having a minimum radius of curvature less than or equal to 200.0 mm.

Advantageously, the tyre comprising a first portion, called the shoulder portion, of the first sidewall which extends from a first axial edge of the tread surface as far as the equator, the first shoulder portion has a theoretical exterior surface having, outside the equator, a minimum radius of curvature Rmin, and at the equator a radius of curvature RE such that Rmin≥RE/2. Thus, it is advantageous to have a relatively thick first sidewall at the outer side of the tyre in order to ensure that the radius of curvature varies very little at the first shoulder portion. Thus, the aerodynamic flow of the air over the tyre is improved.

The radii of curvature and the curvatures are measured by pressurizing to a pressure of 2.5 bar the tyre which is mounted on a measurement rim according to the ETRTO Standards Manual 2021. No load is applied to the tyre.

The first axial edge from which the first portion extends is naturally the end of the tread surface located at the outer side of the tyre.

In preferred embodiments, the tyre does not have any rim protector. The term “does not have any rim protector” is given to mean that the tyre does not have any projecting circumferential rib which is located in the radially lower portion of the sidewall of the tyre (that is to say in the half of the sidewall located radially at the interior of the equator of the tyre) and which is intended to protect the rim edge. Such rim protectors are known to the person skilled in the art and are particularly mentioned in the ETRTO Standards Manual 2021.

The invention will be better understood on reading the following description, which is given purely by way of non-limiting example and with reference to the drawings, in which:

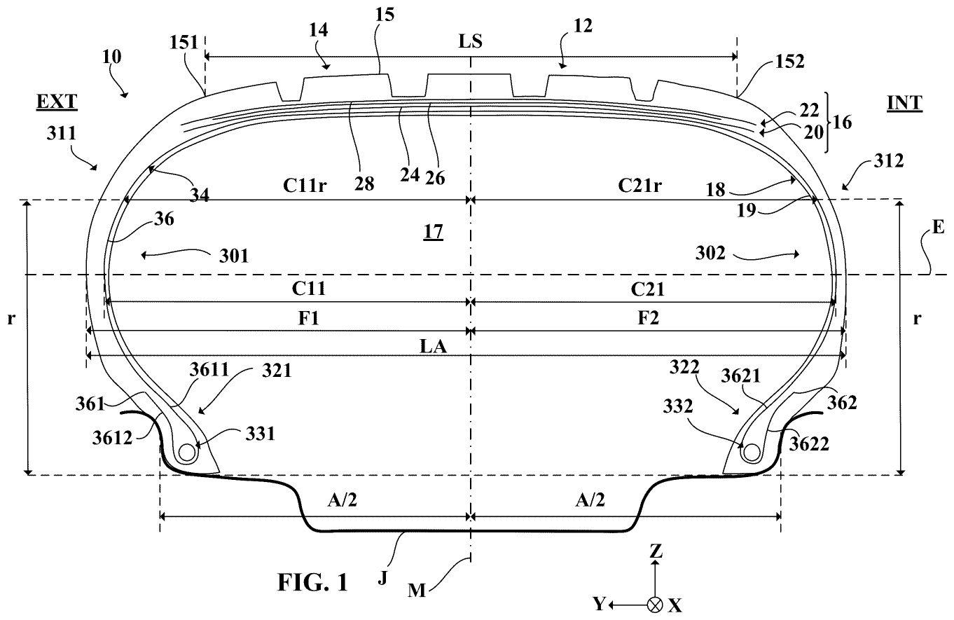

FIG. 1 is a view in a meridian sectional plane of a tyre according to a first embodiment of the invention,

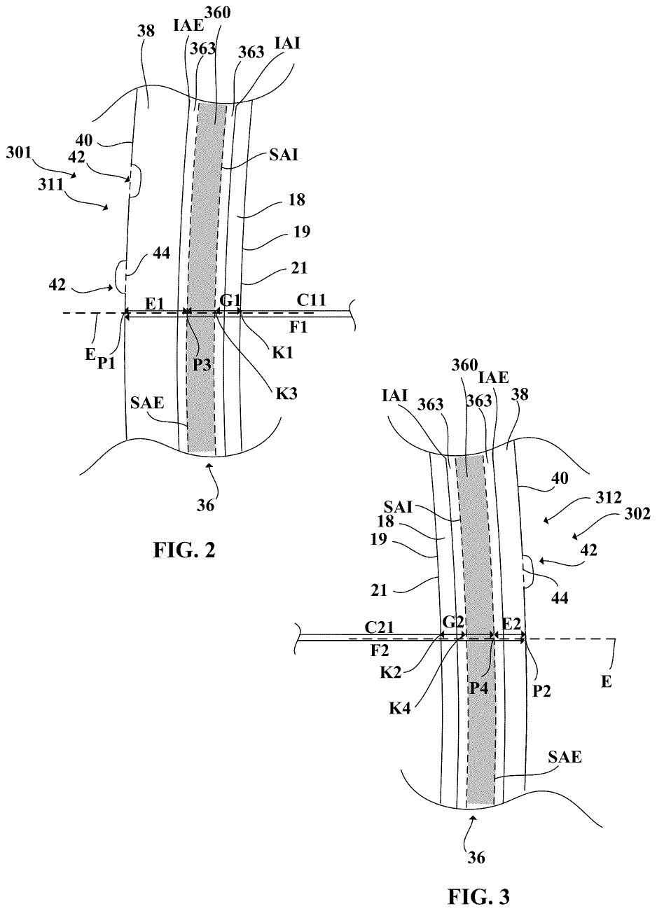

FIGS. 2 and 3 are detailed views illustrating a portion of each first and second sidewall of the tyre of FIG. 1, respectively, and

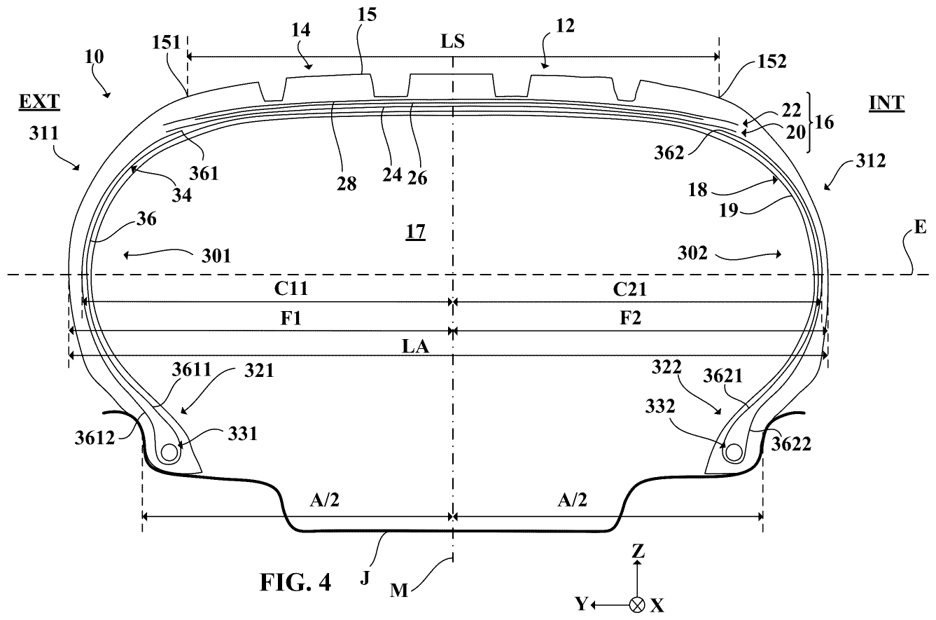

FIGS. 4, 5 and 6 are views analogous to those of FIGS. 1, 2 and 3 of a tyre according to a second embodiment, and

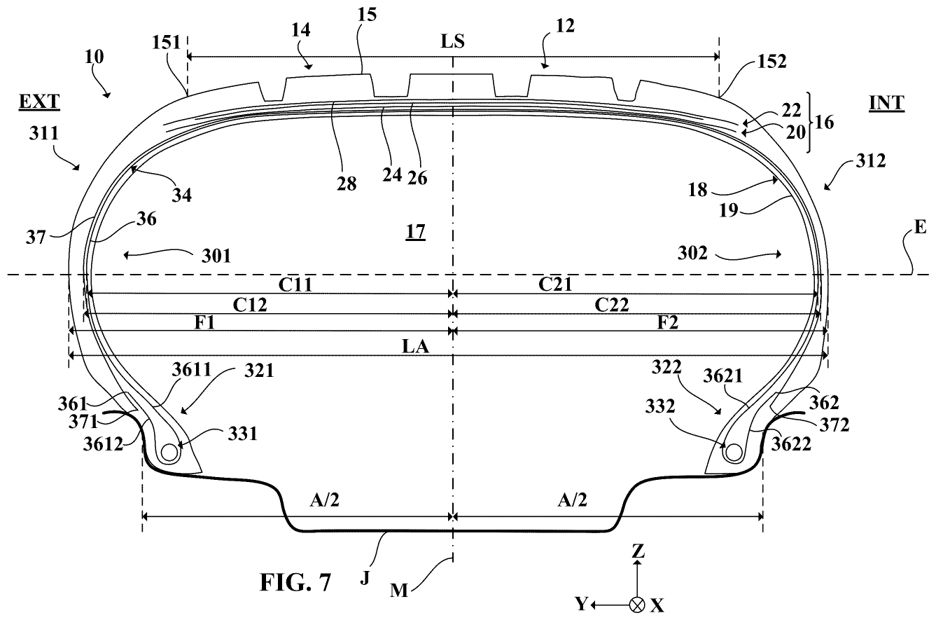

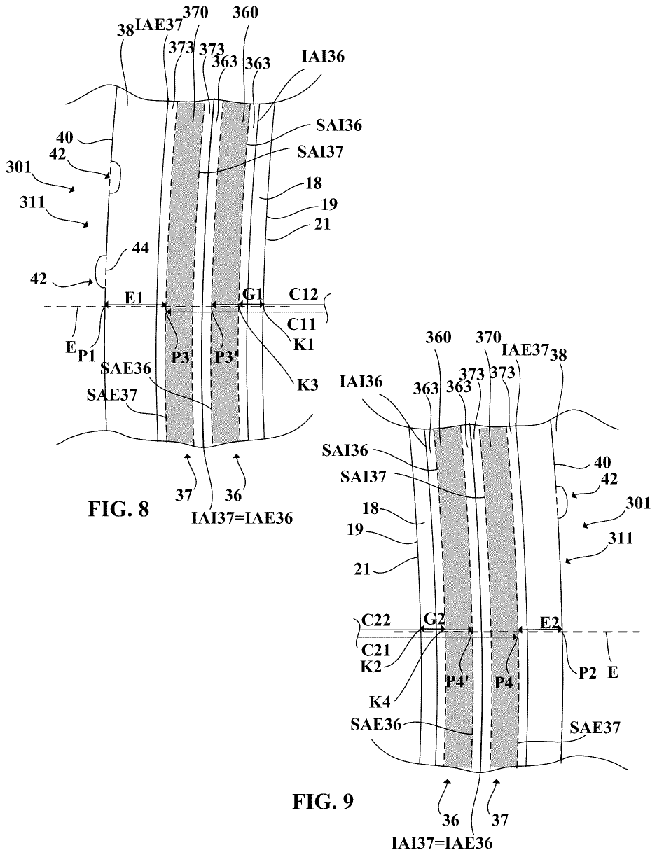

FIGS. 7, 8 and 9 are views analogous to those of FIGS. 1, 2 and 3 of a tyre according to a third embodiment.

A frame of reference X, Y, Z corresponding to the usual axial (Y), radial (Z) and circumferential (X) directions, respectively, of a tyre is shown in the figures.

FIG. 1 shows a tyre for a passenger vehicle according to the invention, denoted by the general reference number 10. The tyre 10 has a substantially toroidal shape about an axis of revolution substantially parallel to the axial direction Y. The tyre 10 is intended for a passenger vehicle and is of the size 235/55 R18 . In the various figures, the tyre 10 is depicted as new, that is, when it has not yet been run. The tyre 10 comprises an inner side INT and an outer side EXT imposed when the tyre 10 is mounted on a vehicle.

In FIG. 1, the tyre 10 is mounted on a mounting support, here a measurement rim J according to the ETRTO Standards Manual 2021, that is to say a rim 7.5 J. The rim J has a median plane M which is arranged with axial equidistance of the first and second edges R1, R2.

The tyre 10 comprises a crown 12 comprising a tread 14 bearing a tread surface 15 intended to come into contact with the ground during running. The tread surface 15 is axially delimited by first and second axial edges 151, 152. The tread surface 15 has an axial width LS which is determined to be 80% of the load capacity of the tyre of the ETRTO Standards Manual 2021, that is to say under a load of 640 kg and at a pressure of 2.5 bar. The axial width LS is such that LR-LS≥10.0 mm with LR being the reference width of the tread surface of the tyre according to the ETRTO Standards Manual 2021. Here, LR=197.0 mm LS=185.0 mm.

The crown 12 comprises a crown reinforcement 16 extending in the crown 12 in the circumferential direction X. The tyre 10 also comprises an airtight inner-liner 18 which is impervious to an inflation gas and is intended to delimit an internal cavity 17 with a mounting support of the tyre 10, once the tyre 10 has been mounted on the mounting support, for example a rim, this cavity being intended to be pressurized with the inflation gas. The airtight inner-liner 18 bears an internal surface 19 of the tyre 10 delimiting the internal cavity 17 of the tyre 10.

The crown reinforcement 16 comprises a working reinforcement 20 and a hoop reinforcement 22. The working reinforcement 20 comprises at least one working layer and, in this instance, comprises two working layers comprising a radially inner working layer 24 and a radially outer working layer 26 arranged radially on the outside of the radially inner working layer 24.

The hoop reinforcement 22 comprises at least one hooping layer and in this case comprises one hooping layer 28.

The crown reinforcement 16 is arranged radially on the inside of the tread 14. In this case, the hoop reinforcement 22, in this case the hooping layer 28, is arranged radially on the outside of the working reinforcement 20 and is therefore interposed radially between the working reinforcement 20 and the tread 14.

The tyre 10 comprises first and second sidewalls 301, 302 continuing the crown 12 radially towards the inside. The tyre 10 further comprises first and second radially internal beads 321, 322 at each first and second sidewall 301, 302, respectively. Each first and second sidewall 301, 302, respectively connects each first and second bead 321, 322 to the crown 12.

The tyre 10 does not have any rim protector.

It is possible to divide the tyre 10 so as to distinguish in particular a first portion 311 called the shoulder portion of the first sidewall 301 which extends from the first axial edge 151 of the tread surface 15 as far as the equator E. It is also possible to distinguish a second portion 312 called the shoulder portion of the second sidewall 302 which extends from the second axial edge 152 of the tread surface 15 as far as the equator E.

The first bead 321 and the first sidewall 301 are arranged at the same side of the median plane M of the rim as the outer side EXT. The second bead 322 and the second sidewall 302 are arranged at the same side of the median plane M of the rim as the inner side INT.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 321, 322. The carcass layer 36 extends radially in each first and second sidewall 301, 302 and axially in the crown 12 radially to the inside of the crown reinforcement 16.

Each first and second bead 321, 322 comprises first and second circumferential reinforcing elements 331, 332 for anchoring the carcass layer 36, respectively. The first and second circumferential reinforcing elements 331, 332 are arranged substantially symmetrically relative to the median plane M of the rim.

The carcass layer 36 anchored in each first and second bead 321, 322 forms a winding around each first and second circumferential reinforcing element 331, 332 of each first and second bead 321, 322, respectively, so that an axially inner portion 3611, 3621 of the carcass layer 36 anchored in each bead 32 is arranged axially on the inside of an axially outer portion 3612, 3622 of the carcass layer 36 anchored in each first and second bead 321, 322 and so that each axial end 361, 362 axially delimiting the carcass layer 36 anchored in each first and second bead 321, 322 is arranged radially on the outside of each first and second circumferential reinforcing element 331, 332. Each axial end 361, 362 of the carcass layer 36 anchored in each first and second bead 321, 322 is arranged radially on the inside of the equator E.

Each working layer 24, 26, hooping layer 28 and carcass layer 36 comprises a polymeric matrix, in this case an elastomeric matrix, in which one or more reinforcing elements of the corresponding layer, in this case filamentary reinforcing elements, are embedded. The structure of the various layers and of the various reinforcing elements is conventional, as described, for example, in the applications WO2021250331, WO2022074341 or WO2022069819.

In particular, with reference to FIGS. 2 and 3, the carcass layer 36, comprises filamentary reinforcing elements 360 embedded in a polymeric matrix 363. The filamentary reinforcing elements 360 extend axially from one axial end to the other of the carcass layer 36 in a main direction forming an angle with the circumferential direction X of the tyre 10 which, in terms of absolute value, is greater than or equal to 60°, preferably ranging from 80° to 90°, and in this case equal to 90°. The carcass layer 36 comprises an axially exterior surface SAE passing through the axially outermost point of each carcass reinforcing element 360, and an axially interior surface SAI passing through the axially innermost point of each carcass reinforcing element 360. The carcass layer 36 is separated from the adjacent compositions with which its polymer matrix 363 is in contact by axially interior and axially exterior interfaces IAI and IAE respectively. In particular, generally and without this being specific to the embodiment described, the axially outermost carcass layer, here the carcass layer 36, is in contact with an external layer 38 which is arranged axially at the outside and in contact with the carcass layer 36, the external layer 38 bearing an external surface 40 of the tyre 10. The axially innermost carcass layer, here the carcass layer 36, is also in contact with the airtight inner-liner 18 bearing the internal surface 19.

Each first and second shoulder portion 311, 312 comprises recessed or protruding moulded elements 42 and has a theoretical external surface 44, discounting the moulded elements 42. The theoretical external surface 44 of the first shoulder portion 311 has a minimum radius of curvature greater than or equal to 25.0 mm and less than or equal to 200.0 mm and here equal to 44.0 mm.

The radius of curvature RE of the tyre 10 at the equator E and the minimum radius of curvature Rmin of the first shoulder portion 311 outside the equator are such that Rmin≥RE/2. Here, Rmin=44.0 mm and RE=51.0 mm.

At the equator E, the thickness E1 between the first point P1 of the theoretical external surface 44 of the first sidewall 301 and the first axially outermost point P3 of the axially outermost carcass layer, here the carcass layer 36, is such that 3.0 mm≤E1≤6.0 mm. Here, E1=4.7 mm.

At the equator E, the thickness E2 between the second point P2 of the theoretical external surface 44 of the second sidewall 302 and the second axially outermost point P4 of the axially outermost carcass layer, here the carcass layer 36, is such that 1.0 mm≤E2≤3.0 mm. Here, E2=1.8 mm.

For each given radial dimension r, each point of the carcass layer 36 located at the outer side EXT has an axial distance relative to the median plane C11r, each point of the carcass layer 36 located at the inner side INT at the same radial dimension r has an axial distance relative to the median plane C21r. This gives |C1ir−C2ir|≤3.0 mm, preferably |C1ir−C2ir|≤2.0 mm, more preferably |C1ir−C2ir|≤1.0 mm and very preferably |C1ir−C2ir|≤0.5 mm.

At the equator E, the tyre 10 has an axial thickness G1 between a point K1 of a theoretical internal surface 21, here the internal surface 19, of the internal cavity 17 and a first axially innermost point K3 of the axially innermost carcass layer 36 at the equator E passing into the first sidewall 301. At the equator E, the tyre 10 has an axial thickness G2 between a point K2 of the theoretical internal surface 21, here the internal surface 19, of the internal cavity 17 and a second axially innermost point K4 of the axially innermost carcass layer 36 at the equator E passing into the second sidewall 302. Here, G1≤6.0 mm and G2≤6.0 mm, preferably G1≤4.0 mm and G2≤4.0 mm and more preferably G1≤3.0 mm and G2≤3.0 mm. Here also, |G1−G2|≤3.0 mm, preferably |G1−G2|≤2.0 mm, more preferably |G1−G2|≤1.0 mm and even more preferably |G1−G2|≤0.5 mm. In particular, in the embodiment illustrated, G1=G2=1.5 mm.

At the equator E, the tyre 10 has an axial distance C11 between the median plane M of the rim and the axially outermost first point P3 of the carcass layer 36 passing into the first sidewall 301. At the equator E, the tyre 10 has an axial distance C21 between the median plane M of the rim and the axially outermost second point P4 of the carcass layer 36 passing into the second sidewall 302. Here, C11=118.3 mm and C21=118.2 mm so that |C11−C21|≤3.0 mm, preferably |C11−C21|≤2.0 mm, more preferably |C11−C21|≤1.0 mm and even more preferably |C11−C21|≤0.5 mm.

Still at the equator, the tyre 10 has an axial distance F1 between the median plane M of the rim and the first point P1 of the theoretical external surface 44 of the first sidewall 301 and an axial distance F2 between the median plane M of the rim and the second point P2 of the theoretical external surface 44 of the second sidewall 302. Here, F1=122.9 mm and F2=120.3 mm so that F1−C11>F2−C21 and so that 2.0 mm≤(F1−C1)−(F2−C2)≤5.0 mm and preferably (F1−C1)−(F2−C2)<3.0 mm. Here, (F1−C1)−(F2−C2)=(122.9−118.3)−(120.3−118.2)=4.6-2.1=2.5 mm.

At the equator E, the tyre 10 has an axial width LA between the points P1 and P2 equal to the total F1+F2 and here equal to 243.2 mm. The tyre 10 has a nominal axial width LN according to the ETRTO Standards Manual 2021 equal to 245 mm. Here, 2×F1>LN and even 2×F1≥LN+0.5 mm, F1 and LN being expressed in mm, LN being the nominal axial width of the tyre according to the ETRTO Standards Manual 2021.

A description will now be given with reference to FIGS. 4 to 9 of the tyres according to second and third embodiments, respectively. In these Figures, elements similar to those of FIGS. 1 to 3 are denoted by identical references.

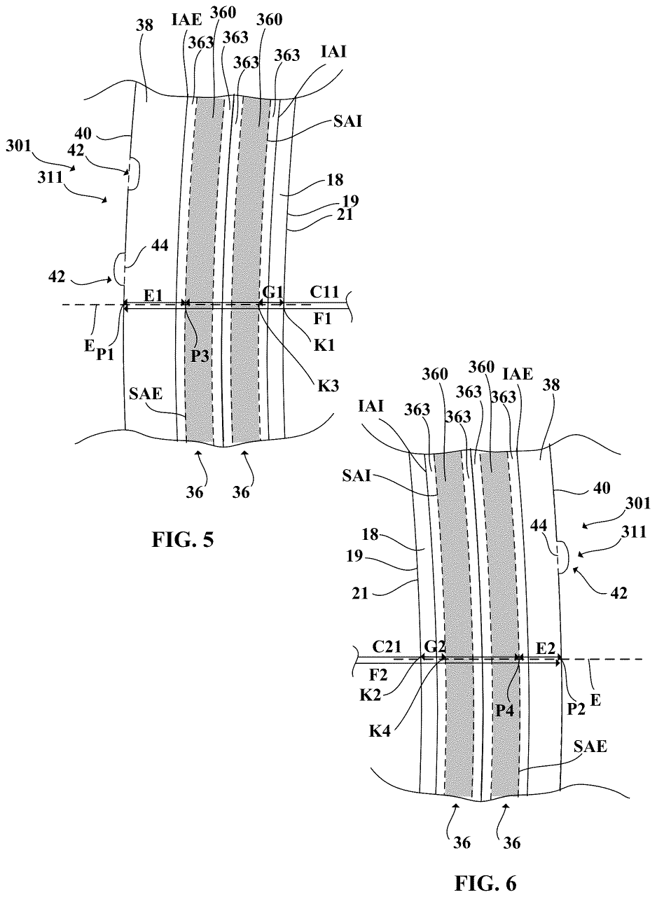

Unlike the tyre according to the first embodiment, in the second embodiment illustrated in FIG. 4 to 6, each axial end 361, 362 of the carcass layer 36 anchored in each first and second bead 321, 322 and forming a winding is arranged radially on the outside of the equator E and even more preferably arranged axially on the inside of the axial ends of the working layer 24 and hooping layer 28 of the crown reinforcement 16. As illustrated in FIG. 5, the first axially outermost point P3 of the carcass layer 36 passing into the first sidewall 301 is the axially outermost point of the axially outermost portion of the carcass layer 36 passing into the first sidewall 301. As illustrated in FIG. 6, the second axially outermost point P4 of the carcass layer 36 passing into the second sidewall 302 is the axially outermost point of the axially outermost portion of the carcass layer 36 passing into the second sidewall 302.

Unlike the tyre according to the first and second embodiments, the carcass reinforcement 34 of the tyre 10 according to the third embodiment of FIGS. 7 to 9 comprises first and second carcass layers 36, 37 anchored in each first and second bead 321, 322. Each axial end 371, 372 of the second carcass layer 37 is arranged axially at the outside of each axially exterior portion 3612, 3622 of the first carcass layer 36. In this third embodiment, only the first carcass layer 36 is anchored in each first and second bead 321, 322 by means of the first and second circumferential anchoring reinforcing elements 331, 332.

Each first and second carcass layer 36, 37 comprises an axially exterior surface SAE36, SAE37 passing through the axially outermost point of each carcass reinforcing element 360, 370 and an axially interior surface SAI36, SAI37 passing through the axially innermost point of each carcass reinforcing element 360, 370. Each first and second carcass layer 36, 37 is separated from the adjacent compositions with which its polymer matrix 363, 373 is in contact by axially interior and axially exterior interfaces IAI36, IAI37 and IAE36, IAE37 respectively.

At the equator E, each first and second axially outermost first and second point of the axially outermost carcass layer is each axially outermost point P3, P4 of the second carcass layer 37.

At the equator E, in addition to the axial distance C11 between the median plane M of the rim and the axially outermost first point P3 of the second carcass layer 37 passing into the first sidewall 301, the tyre 10 has a distance C12 between the median plane M of the rim and the first axially outermost point P3′ of the first carcass layer 36 passing into the first sidewall 301.

At the equator E, in addition to the axial distance C21 between the median plane M of the rim and the axially outermost second point P4 of the second carcass layer 37 passing into the second sidewall 302, the tyre 10 has a distance C22 between the median plane M of the rim and the first axially outermost point P4′ of the first carcass layer 36 passing into the second sidewall 302. In the third embodiment, C11=118.3 mm, C12=117.1 mm, C21=118.2 mm and C22=117.0 mm so that |C11−C21|≤0.5 mm and |C12−C22|≤0.5 mm.

In the third embodiment, F1=122.9 mm and F2=120.3 mm so that F1−C11>F2−C21, F1−C12>F2−C22 and so that 2.0 mm≤(F1−C11)−(F2-C21)≤5.0 mm and preferably (F1−C11)−(F2−C21)<3.0 mm and 2.0 mm≤(F1−C12)−(F2−C22)≤5.0 mm and preferably (F1−C12)−(F2−C22)<3.0 mm. Here, (F1−C11)−(F2−C21)=(F1−C12)−(F2−C22)=2.5 mm.

### COMPARATIVE TESTS

Tyres according to the invention and as described above and sample tyres having completely symmetrical sidewalls relative to the median plane of the rim have been tested.

The four sample tyres were mounted on a vehicle which was positioned in a wind tunnel under conventional test conditions. Then, this same vehicle fitted with four tyres according to the invention was placed under the same test conditions. In both cases, the product S x Cx was determined, where S is the front surface of the vehicle and Cx is the air penetration coefficient of the vehicle. A significant reduction of the product S x Cx was measured when the sample tyres were replaced by the tyres according to the invention, which demonstrates the aerodynamic improvement of the invention.

The invention is not limited to the embodiments described above.

It is possible to exploit the invention in the case of a tyre comprising a plurality of first and a plurality of second circumferential anchoring reinforcing elements, a portion of the carcass layer being arranged axially between two of the at least first circumferential reinforcing elements in the first bead and between two of the at least second circumferential reinforcing elements in the second bead, for example as described in WO2021/123522.

In order to maximize the aerodynamic improvement, the invention will preferably be used with a mounting support having an outer face which is as concealed as possible.

Still in order to maximize the aerodynamic improvement, the moulded elements will preferably be moulded in a recessed manner. If the moulded elements are moulded in a protruding manner, the maximum height of each of these moulded elements relative to the theoretical external surface is less than or equal to 0.2 mm.

1.-15. (canceled)

16. A tire for a passenger vehicle, the tire having an outer side and an inner side which are imposed when the tire is mounted on the passenger vehicle, the tire comprising:
a crown comprising a crown reinforcement;
first and second beads;
first and second sidewalls which connect each first and second bead to the crown, respectively;
a carcass reinforcement comprising at least one carcass layer, the at least one carcass layer being anchored in each first and second bead and extending radially in each first and second sidewall and axially in the crown radially internally with respect to the crown reinforcement;
a median plane of a rim which is constituted by the median plane of a measurement rim of the tire according to ETRTO Standards Manual 2021 when the tire is mounted on the measurement rim, the first sidewall and the first bead being arranged at a same side of the median plane of the rim as the outer side of the tire, the second sidewall and the second bead being arranged at a same side of the median plane of the rim as the inner side of the tire, each first and second bead comprising at least first and second circumferential reinforcing elements for anchoring the at least one carcass layer, respectively, the first and second circumferential reinforcing elements being arranged substantially symmetrically relative to the median plane of the rim,
wherein the tire has an axial distance C1i, at an equator, between the median plane of the rim and a first axially outermost point of the at least one carcass layer which passes into the first sidewall,
wherein the tire has an axial distance C2i, at the equator, between the median plane of the rim and a second axially outermost point of the at least one carcass layer which passes into the second sidewall,
wherein the tire has an axial distance F1, at the equator, between the median plane of the rim and a first point of a theoretical external surface of the first sidewall,
wherein the tire has an axial distance F2, at the equator, between the median plane of the rim and a second point of a theoretical external surface of the second sidewall,
wherein the tire has an axial thickness G1, at the equator, between a point of a theoretical internal surface of an internal cavity of the tire and a first axially innermost point of the at least one carcass layer which is axially innermost with respect to the equator passing into the first sidewall,
wherein the tire having an axial thickness G2, at the equator, between a point of the theoretical internal surface of the internal cavity of the tire and a second axially innermost point of the at least one carcass layer which is axially innermost with respect to the equator passing into the second sidewall,
wherein 2×F1>LN with LN being a nominal axial width of the tire according to the ETRTO Standards Manual 2021,
wherein |C1i−C2i|≤3.0 mm,
wherein F1−C1i>F2−C2i, and
wherein G1≤6.0 mm and/or G2≤6.0 mm.

17. The tire according to claim 16, wherein |C1i−C2i|≤2.0 mm.

18. The tire according to claim 16, wherein (F1−C1i)−(F2−C2i)≥2.0 mm.

19. The tire according to claim 16, wherein (F1−C1i)−(F2−C2i)≤5.0 mm.

20. The tire according to claim 16, wherein G1≤4.0 mm and/or G2≤4.0 mm.

21. The tire according to claim 16, wherein |G1−G2|≤3.0 mm.

22. The tire according to claim 16, wherein the tire has an axial thickness E1, at the equator, between the first point of the theoretical exterior surface of the first sidewall and the first axially outermost point of the at least one carcass layer which is axially outermost at the equator such that E1≥3.0 mm.

23. The tire according to claim 16, wherein the tire has an axial thickness E1, at the equator, between the first point of the theoretical exterior surface of the first sidewall and the first axially outermost point of the at least one carcass layer which is axially outermost at the equator such that E1≤6.0 mm.

24. The tire according to claim 16, wherein the tire has an axial thickness E2, at the equator, between the second point of the theoretical exterior surface of the second sidewall and the second axially outermost point of the at least one carcass layer which is axially outermost at the equator such that E2≥1.0 mm.

25. The tire according to claim 16, wherein the tire has an axial thickness E2, at the equator, between the second point of the theoretical exterior surface of the second sidewall and the second axially outermost point of the at least one carcass layer which is axially outermost at the equator such that E2≤3.0 mm.

26. The tire according to claim 16, wherein 2×F1>LN+0.5 mm, F1 and LN being expressed in mm.

27. The tire according to claim 16, further comprising a tread surface having an axial width LS such that LR−LS≥10.0 mm with LR being a reference width of the tread surface of the tire according to the ETRTO Standards Manual 2021, LS being determined at 80% of a load capacity of the tire of the ETRTO Standards Manual 2021 and at a pressure of 2.5 bar.

28. The tire according to claim 27, further comprising a first shoulder portion of the first sidewall extending from a first axial edge of the tread surface as far as the equator, the first shoulder portion having a theoretical exterior surface having a minimum radius of curvature greater than or equal to 25.0 mm.

29. The tire according to claim 27, further comprising a first shoulder portion of the first sidewall which extends from a first axial edge of the tread surface as far as the equator, the first shoulder portion having a theoretical exterior surface having a minimum radius of curvature Rmin less than or equal to 200.0 mm.

30. The tire according to claim 27, further comprising a first shoulder portion of the first sidewall which extends from a first axial edge of the tread surface as far as the equator, the first shoulder portion having a theoretical exterior surface having, outside the equator, a minimum radius of curvature Rmin, and at the equator a radius of curvature RE such that Rmin≥RE/2.
